(19) United States
(12) Patent Application Publication
(10) Pub. No.: US 2016/0288484 A1
(43) Pub. Date: Oct. 6, 2016

(54) END CAPS FOR PRINTING SUBSTRATE ROLLS

(71) Applicants: Kasey Coussens, Hillsboro, OR (US); Daniel B. Meyer, Lake Oswego, OR (US); Robert W. Martell, Portland, OR (US)

(72) Inventors: Kasey Coussens, Hillsboro, OR (US); Daniel B. Meyer, Lake Oswego, OR (US); Robert W. Martell, Portland, OR (US)

(21) Appl. No.: 14/675,330

(22) Filed: Mar. 31, 2015

(51) Int. Cl. B41F 27/00; B41F 25/00

(52) U.S. Cl. CPC B41F 27/00; B41F 25/00

(57) ABSTRACT

End caps for printing substrate rolls that are configured to engage with a print roll retaining mechanism of a printer in order to regulate total web tension of a printing substrate during a printing operation are shown and described. Each of the end caps has a cylindrical body including an attachment mechanism for attaching the end cap to the printing substrate roll; a continuously curved outer wall longitudinally aligned with the cylindrical body and configured to define a first component of the total web tension; and a central protuberance that is concentric with the continuously curved outer wall and longitudinally aligned with the cylindrical body, an outer face of the central protuberance being extended beyond an outer lip edge of the curved outer wall, the central protuberance configured to define a second component of the total web tension.

### BACKGROUND

The present disclosure relates generally to end caps for defining web tension of a printing substrate roll during a printing operation. In particular, end caps having a curved outer wall for defining a first component of the total web tension and a central protuberance for defining a second component of the total web tension are described.

It is desirable that unrolling of a rolled printing substrate through a printer during a printing operation has a smooth feed and a steady unwind pressure. Specifically, it is desirable that tension on the printing substrate (i.e., web tension) remain low enough to allow unrolling, but be high enough to prevent over-unrolling. Typically, the printing substrate roll includes end caps attached at opposing ends. Web tension is regulated via friction between the end cap and a saddle with a spring member, which is configured to receive and releasable retain the end cap. Specifically, friction between an inner wall of the saddle and an outer curved surface of a protrusion of the end cap, as well as pressure applied on a face of the protrusion by the spring member, creates the web tension required to regulate unrolling of the printing substrate.

Known end caps are not entirely satisfactory for the range of applications in which they are employed. For example, web tension produced by existing end caps is defined by dimensions of the protrusion. Accordingly, if length of the protrusion is increased or decreased, a height of the outer cursed surface is similarly increased or decreased. Thus, control over and/or regulation of web tension is limited and can result in undesired unrolling characteristics during a printing operation. In some cases, these undesired rolling characteristics can cause misprinting.

In addition, it is desirable to label and/or tag rolls of paper on the end caps for identification of the printing substrate roll, however, conventional end caps are difficult to label. Normally, the protrusion is surrounded by a conical wall. Thus, the most convenient and/or readable location to place a label and/or tag is on the face of the protrusion. Specifically, the label and/or tag can be adhered to the flat surface of the face in order to be easily read by a user and/or a scanner. Contact between the spring member and the face during rotation of the printing substrate roll will likely destroy the tag. Alternatively, the tag can be placed on the conical wall, which may be more difficult for the tag to adhere to and/or make the tag more difficult to read.

Thus, there exists a need for printing substrate roll end caps that improve upon and advance the design of known printing substrate roll end caps. Examples of new and useful printing substrate roll end caps relevant to the needs existing in the field are discussed below.

Disclosure addressing one or more of the identified existing needs is provided in the detailed description below. Examples of references relevant to printing substrate roll end caps include U.S. Patent References: U.S. Pat. No. 6,634,814, U.S. Pat. No. 7,063,470, and U.S. Pat. No. 7,664,257. The complete disclosures of the above patents are herein incorporated by reference for all purposes.

### SUMMARY

The present disclosure is directed to end caps for printing substrate rolls that are configured to engage with a print roll retaining mechanism of a printer in order to regulate total web tension of a printing substrate during a printing operation. Each of the end caps has a cylindrical boy including an attachment mechanism for attaching the end cap to the printing substrate roll; a continuously curved outer wall longitudinally aligned with the cylindrical body and configured to define a first component of the total web tension; and a central protuberance that is concentric with the continuously curved outer wall and longitudinally aligned with the cylindrical body, an outer face of the central protuberance being extended beyond an outer lip edge of the curved outer wall, the central protuberance configured to define a second component of the total web tension.

### BRIEF DESCRIPTION OF THE DRAWINGS

FIG. 1 is a side elevation view of a first side of a first example of an end cap for a printing substrate roll.

FIG. 2 is a side elevation view of a second side of the first example end cap shown in FIG. 1.

FIG. 3 is a top plan view of the first example end cap shown in FIG. 1.

FIG. 4 is a cross-sectional view of the first example end cap shown in FIG. 1.

FIG. 5 is a top plan view of the first example end cap shown in FIG. 1 with the second side inserted into a printing substrate roll.

FIGS. 6A and 6B show top plan views of the first example end cap with the second end inserted into the printing substrate roll and the first end releasably engaged with a saddle.

### DETAILED DESCRIPTION

The disclosed printing substrate roll end caps will become better understood through review of the following detailed description in conjunction with the figures. The detailed description and figures provide merely examples of the various inventions described herein. Those skilled in the art will understand that the disclosed examples may be varied modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various printing substrate roll end caps are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

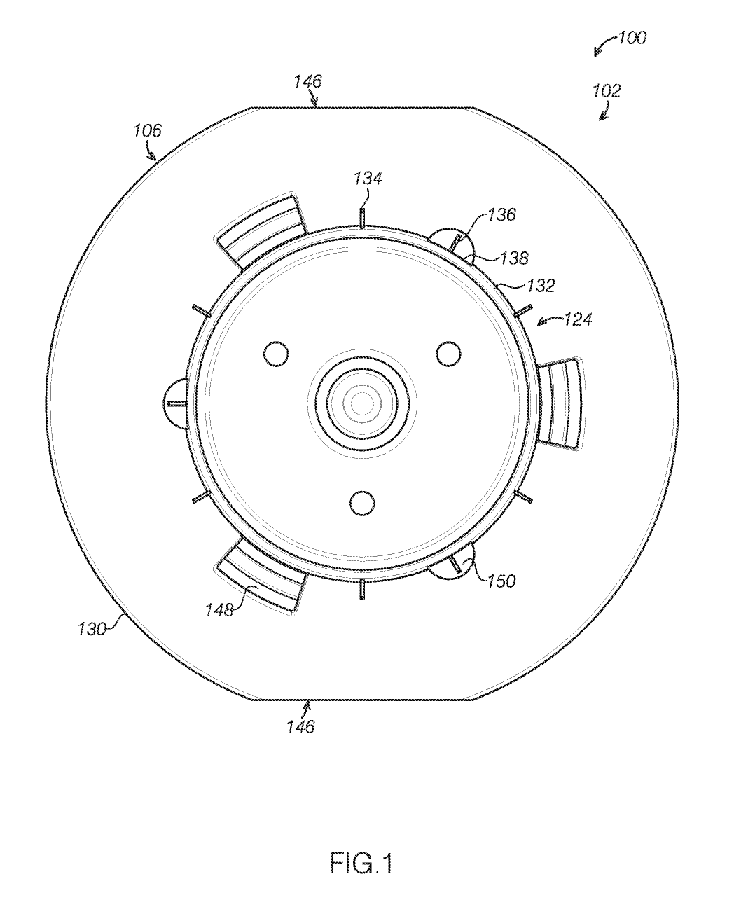

With reference to FIGS. 1-6B, first example of a printing substrate roll end cap, end cap 100, will now be described. End cap 100 is generally cylindrical in shape and has a generally cylindrical body 102 including a first side 104 and a second side 106. First side 104 includes an attachment mechanism 124 for releasable attachment of a printing substrate roll 108. Second side 106 is configured to engage with a saddle 110 in printer and regulate web tension of the printing substrate during a printing operation. Specifically, Second side 106 includes a continuously curved outer wall 112 configured to contact an internal wall 114 of saddle 110 to control a first component of the total web tension. A central protuberance 116 configured to contact a spring member 118 of saddle 110 and control a second component of the total web tension.

End cap 100 further includes a circular lateral wall 120 encompassed by curved outer wall 112. In other words, lateral wall 120 and outer wall 112 form a recess 122. Recess 122 is configured to receive an identification tag and/or label. For example, an RFID tag can be attached to the circular lateral wall within the recess.

End cap 100 functions to allow control, regulation, and/or refinement of web tension during a printing operation. Specifically, dimensions of the continuously curved outer wall wall and dimensions of the central protuberance are independent of each other. Therefore, tension caused by friction between the continuously curved wall and the inner wall of the saddle can be independently regulated from tension caused by friction and/or pressure of the spring member on the central protuberance.

For example, a height of the wall can be selected to be increased or decreased to correspondingly increase or decrease the first component of the total web tension. In another example, a length of the central protuberance can be selected to be increased or decreased to correspondingly increase or decrease the second component of the total web tension. In even another example, width of the central protuberance can be selected to be increased or decreased and correspondingly increase or decrease the second component of the total web tension.

Additionally or alternatively, as described above, the circular lateral wall can be used for attachment of an identification label and/or tag.

End cap 100 addresses many of the shortcomings existing with conventional end caps. For example, web tension can be more tightly controlled, regulated, and/or optimized because dimensions of the curved outer wall and the central protuberance are independently selectable to cooperatively define the total web tension. In other words, dimensions of the curved outer wall define a first component of the total web tension and dimensions of the central protuberance define a second component of the total web tension. The first component and the second component can be independently selected to refine the web tension of a printing operation, which can be optimized for specific printing conditions (e.g., a type of printing substrate, an amount of remaining substrate on the roll, a speed of printing, etc.). In another example, wear on an identification label and/or tag is limited as it is protected within the recess. Further, the identification label and/or tag is easily readable by a user and/or scanner.

As shown in FIGS. 1, 3, 4, and 5A, first side 104 includes attachment mechanism 124. In the present example, attachment mechanism is an insertable cylindrical arm 132. An outer surface of cylindrical arm 132 includes longer fins 134, shorter fins 136, and shallow rectangular depressions 138. Longer fins 134 extend from an interior surface 140 of an abutment wall 130 toward a distal end of cylindrical arm 132. Shorter fins 134 are aligned with depressions 138 and are extended toward a distal end 142 of cylindrical arm 132. More specifically, depressions 138 extend through abutment wall 130 and toward distal end 142, while shorter fins 134 originate at distal ends of depressions 138 and extend toward the distal end of cylindrical arm 132. Each of fins 134 and 138 extend partially over the outer surface of cylindrical arm 132 and are tapered. In the present example, the length of the longer fins is equal to the combined length of the depressions and the shorter fins.

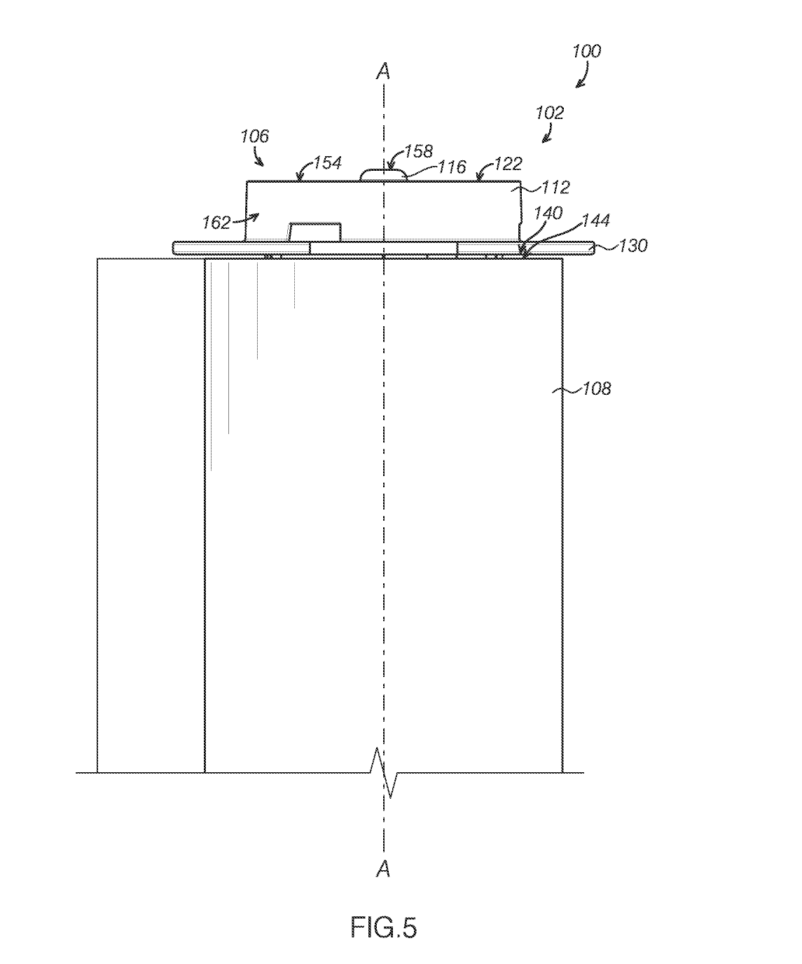

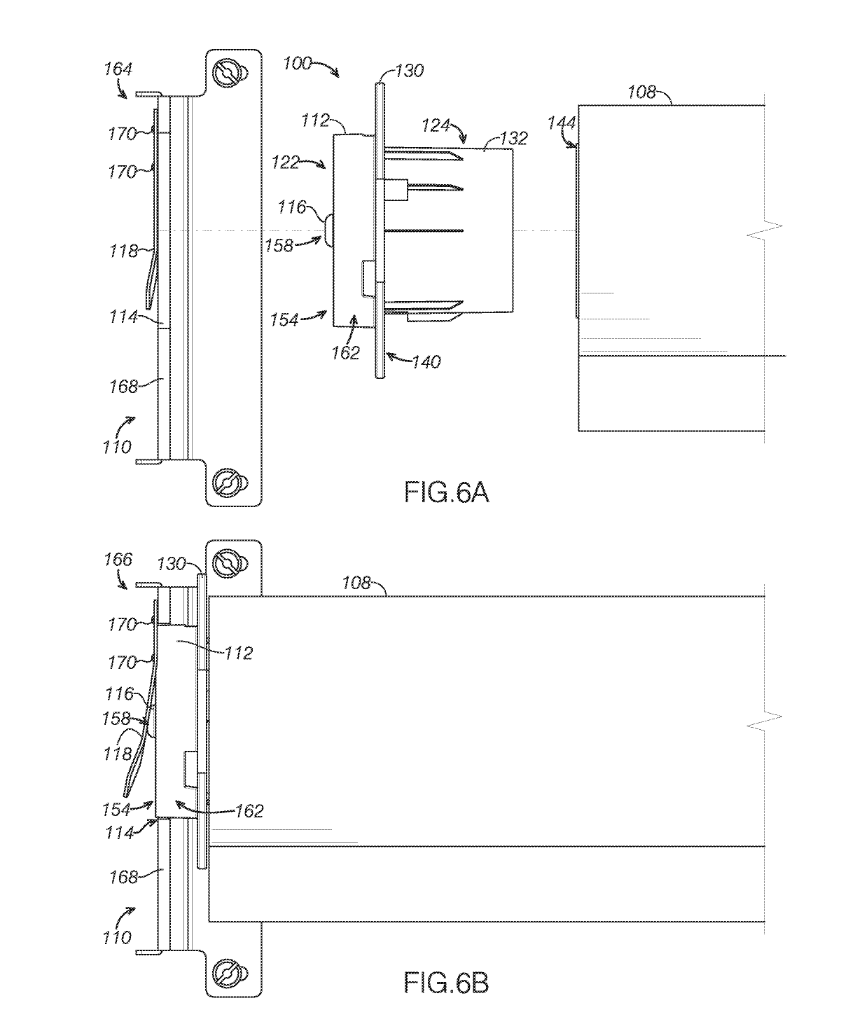

FIGS. 5, 6A, and 6B show that cylindrical arm 132 is configured to be selectively inserted into printing substrate roll 108. Specifically, the cylindrical arm is configured to be interference fit (i.e., friction fit) within a core of the printing substrate roll. The tapered shape of the fins allows the cylindrical arm to be guided into the printing substrate roil hen the cylindrical arm and the printing substrate roll are longitudinally aligned (i.e., aligned along longitudinal axis A-A shown in FIG. 5) and a pushing force is applied on either or both of the end cap and the printing substrate roll. Friction and compressive forces between the fins and an interior wall of the core of the printing substrate roll prevent the end cap from being removed from the printing substrate roll until a pulling force is applied on either or both of the end cap and the printing substrate roll.

It will be appreciated that in alternate examples the attachment mechanism can have a different configuration for attachment of the end cap to the printing substrate roll. In one alternate example, the attachment mechanism can be a smooth insertable arm (i.e., an arm lacking fins on an exterior surface. In another alternate example, the attachment mechanism can include three or more prongs that are slightly compressible in order to be fitted within the printing substrate roll. In this example, the prongs can each include a flange at the distal end (i.e., interior-most end) of the prong for additional gripping of the interior surface of the printing substrate roll. It will be further appreciated that the attachment mechanisms described above are mere examples and the end cap can include any attachment mechanism known or yet to be discovered.

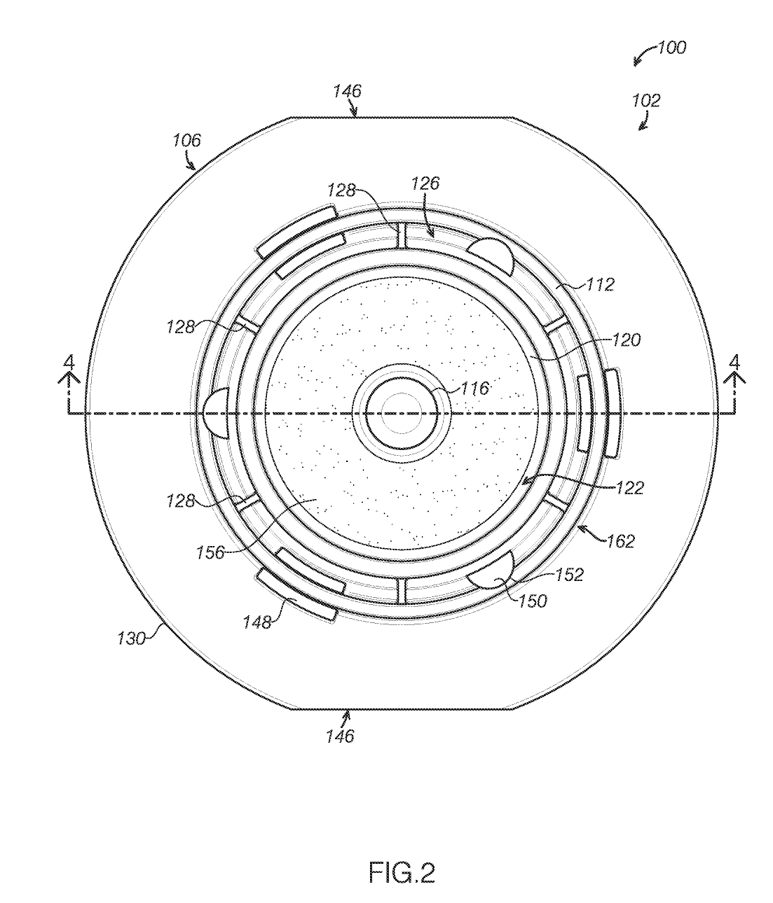

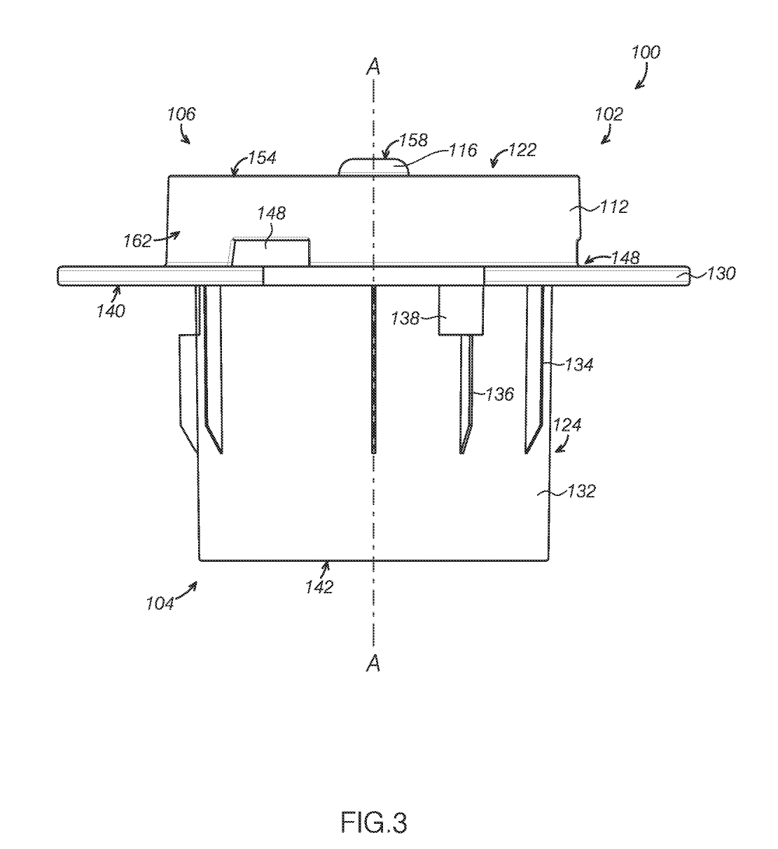

Returning to FIGS. 5, 6A, and 6B, interior surface 140 of abutment wall 130 is configured to be abutted to an end 144 of the printing substrate roll when cylindrical arm 132 is inserted into printing substrate roll 108. FIGS. 1 and 2 show that a perimeter of abutment wall 130 is generally circular with two flat edges. The flat edges are configured to prevent and/or limit rolling of a printing substrate roll when the roll is rested on a flat surface. It will be appreciated that in alternate examples the abutment wall perimeter can include more or fewer flat surfaces. As depicted in FIGS. 3, 4, and 6A, abutment wall 130 is laterally extended outward from cylindrical body 102 and divides second side 106 from first side 104.

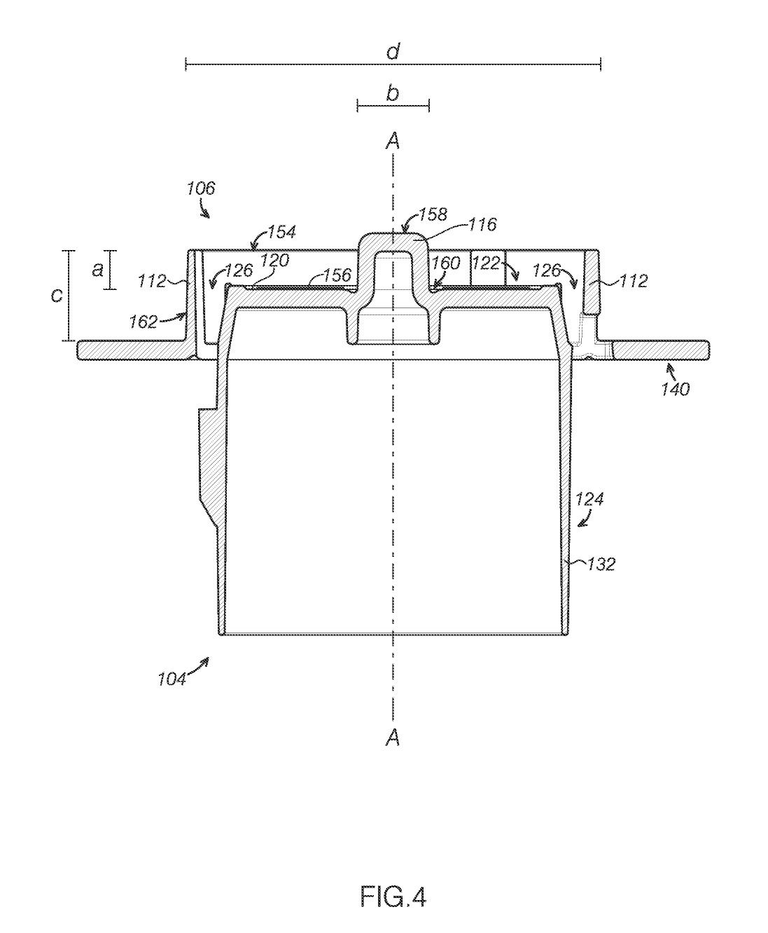

As can be seen in FIG. 2 and as described above, second side 106 of body 102 includes continuously curved outer wall 112 having an outer surface 162, central protuberance 116, and circular lateral wall 120. Central protuberance 116 is disposed within outer wall 112 and is concentric with outer wall 112 (i.e., the outer wall and the central protuberance have a coinciding center). As shown in FIGS. 3 and 4, continuously curved outer wall 112 and central protuberance 116 are longitudinally aligned with generally cylindrical body 102 (i.e., aligned along longitudinal axis A-A).

Circular lateral wall 120 is encompassed by curved outer wall 112 and is disposed inwardly relative to an outer lip edge 154 of curved outer wall 112 (shown in FIG. 4). Together circular lateral wall 120 and curved outer wall 112 form recess 122. Recess 122 is configured to receive an identification tag and/or label. In the present example, an RFID tag 156 is adhered to the circular lateral wall within the recess. In alternate examples, a printed or colored label can be adhered to the circular lateral wall within the recess.

Also shown in FIG. 2, second side 106 further includes a trough 126 having braces 128 radially extended between outer wall 112 and circular lateral wall 120. Openings 148 and 150 in abutment wall 130 are radially arranged between braces 128 and are proximal to curved outer wall 112. Curved outer wall 112 includes grooves 152 that are aligned with openings 150. Openings 148 are extended below outer curved wail 112 and outward through curved wall 112 towards outer lip edge 154 (as shown in FIGS. 3, 5, and 6A). Openings 148 are shaped as to allow attachment of a snap-in adapter for fitting into differently sized printing substrate rolls, while openings 150 are shaped as to provide a gripping surface/location during manufacturing of the end cap. It will be appreciated that in alternate examples the end cap can include more or fewer openings of similar or different shapes.

Turning now to FIGS. 3 and 4, a base 160 of central protuberance 116 is attached to and/or continuous with a center of circular lateral wall, and an opposing side of the central protuberance, a face 158, is extended beyond outer lip edge 154 of curved outer wall 112. Accordingly, face 158 is an outermost portion of end cap 100. As shown in FIG. 4, central protuberance 116 has a height a and a width b. Further, curved outer wall 112 has a height c and a width d. It will be appreciated that, as the curved outer wall substantially comprises a circle, the width d is a diameter of the circle.

As stated above and shown in FIGS. 6A and 6B, second side 106 is configured to engage with saddle 110 (i.e., a saddle within the printer) and regulate web tension of the printing substrate during a printing operation. Continuously curved outer wall 112 is configured to contact internal wall 114 of saddle 110 to define a first component of the total web tension, and central protuberance 116 is configured to contact spring member 118 of saddle 110 and define a second component of the total web tension.

FIG. 6A shows end cap 100 and saddle 110 in a disengaged position 164, while. FIG. 6B shows end cap 100 and saddle 110 in an engaged position 166. Spring member 118 is attached to a saddle main body 168 via attachment members 170. Inner wall 114 of saddle 118 is configured to receive and support curved outer wall 112. Spring member 118 is configured to lay substantially flat against saddle main body 168 in disengaged position 164, and is further configured to be flexed outwardly away from the saddle main body in engaged position 166.

Specifically, friction between the curved outer wall of the end cap and the inner wall of the saddle and surface area of the curved outer wall define the first component of the total web tension. Accordingly, a height of the continuously curved outer wall (i.e., the height c) and a diameter of the curved outer wall (i.e., the width d) are selectable to define the first component of the total web tension. Further, the surface area of the continuously curved outer wall has a direct relationship with the first component of the total web tension. For example, the surface area (e.g., the height, the diameter of the circle, etc.) of the continuously curved outer wall is selectable to be an increased value to correspondingly increase the first component. In another example, the surface area (e.g., the height, the diameter of the circle, etc.) of the continuously curved outer wall is selectable to be a decreased value to correspondingly decrease the first component.

The second component of the total web tension is defined by a degree of flex of the spring member and friction between the spring member and the face of the central protuberance. Accordingly, a height (i.e., the height a) and a width (i.e., the width b) of the central protuberance are each selectable to define the second component of the total web tension. Further, the length of the central protuberance and the width of the central protuberance each have a direct relationship with the second component of the total web tension. In one example, one or more of the length of the central protuberance and the width of the central protuberance is selectable to be an increased distance to correspondingly increase the second component. In another example, one or more of the length of the central protuberance and the width of the central protuberance is selectable to be a decreased distance to correspondingly decrease the second component. In other words, a greater degree of flex of the spring member (i.e., a greater distance between the spring member and the saddle main body) and/or a greater degree of surface area contact between the spring member and the face of the central protuberance results in an increase in the second component of the web tension.

It will be appreciated that in some examples web tension can be regulated or defined by a material comprising or disposed on the outer surface of the curved outer wall and/or the face of the central protuberance. Both the first component of web tension and the second component of web tension are affected and defined by friction (e.g., friction between the curved outer wall and the inner wall of the saddle and friction between the face and the spring member, respectively). Accordingly, low-friction materials (e.g., polished plastic, polished metal, grease, etc.) can comprise or he coated on the outer surface of the curved outer wall to decrease the first component of the total web tension and high-friction materials (e.g., textured plastic, textured metal, rubber, etc.) can comprise or be coated on the outer surface of the curved wall to increase the first component of the total web tension. Similarly, low-friction materials (e.g., polished plastic, polished metal, grease, etc.) can comprise or be coated on the face of the central protuberance to decrease the second component of the total web tension and high friction materials (e.g., textured plastic, textured metal, rubber, etc.) can comprise or be coated on the face of the central protuberance to increase the second component of the total web tension.

In some examples, a printing system can include a plurality of end caps. The plurality of end caps can have a variety of dimensions for the curved outer wall and the central protuberance. Additionally or alternatively, the plurality of end caps can include end caps having a variety of materials disposed on or comprising the outer surfaces the curved outer walls and/or the faces of the central protuberances. Pairs of end caps can be selectively used to convey and/or generate a specific web tension during a printing operation. Accordingly, the web tension can he optimized for specific printing conditions (i.e., type of printing substrate, a size of the roll, a speed of the printing operation, etc.).

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiting nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. An end cap for a printing substrate roil configured to engage with a print roll retaining mechanism of a printer and to regulate a total web tension of a printing substrate as the printing substrate is fed from the printing substrate roll through the printer during a printing operation, the end cap having a generally cylindrical body comprising:
an attachment mechanism on a first side of the end cap configured to attach the end cap to the printing substrate roll;
a continuously curved outer wall on a second opposing side of the end cap, the continuously curved outer wall being longitudinally aligned with the generally cylindrical body, the continuously curved outer wall configured to define a first component of the total web tension; and
a central protuberance that is concentric with the continuously curved outer wall, the central protuberance being longitudinally aligned with the generally cylindrical body, an outer face of the central protuberance being extended beyond an outer lip edge of the curved outer wall, the central protuberance configured to define a second component of the total web tension.

2. The end cap of claim 1, further comprising an abutment wall laterally extended outward from the cylindrical body, the abutment wall being disposed between the attachment mechanism and the continuously curved outer wall the abutment wall configured to be abutted to an end of the printing substrate roll.

3. The end cap of claim 1, wherein the attachment mechanism comprises a cylindrical arm configured to be interference fit into the printing substrate roll, the cylindrical arm being longitudinally aligned with the generally cylindrical body.

4. The end cap of claim 1, further comprising a circular lateral wall encompassed by the continuously curved outer wall.

5. The end cap of claim 4, wherein a base of the central protuberance is attached to a center of Me circular lateral wall, the base being on an opposing end of the central protuberance relative to the outer face.

6. The end cap of claim 4, wherein the circular lateral is inwardly disposed relative to the outer lip edge of the cylindrical outer wall, an outer surface of the circular lateral wall being a recess surface configured to receive an identification tag.

7. The end cap of claim 6, wherein the identification tag is an RFID tag.

8. The end cap of claim 1, wherein an outer surface of the continuously curved outer wall is configured to contact an inner wall of a saddle of the print roll retaining mechanism, and a surface area of the continuously curved outer wall is selectable to define the first component of the total web tension, the surface area of the continuously curved outer having a direct relationship with the first component.

9. The end cap of claim 8, wherein the surface area of the continuously curved outer wall is selectable to be an increased surface area to correspondingly increase the first component.

10. The end cap of claim 8, wherein the surface area of the continuously curved outer wall is selectable to be a decreased surface area to correspondingly decrease the first component.

11. The end cap of claim 1, wherein the outer face of the central protuberance is configured to contact a tensioning member of the print roll retaining mechanism, and a height and a width of the central protuberance are each selectable to define the second component of the total web tension, the length of the central protuberance and the width of the central protuberance each having a direct relationship with the second component.

12. The end cap of claim 11, wherein one or more of the height of the central protuberance and the width of the central protuberance is selectable to be an increased distance to correspondingly increase the second component.

13. The end cap of claim 11, wherein one or more of the height of the central protuberance and the width of the central protuberance is selectable to be a decreased distance to correspondingly decrease the second component.

14. The end cap of claim 1, wherein:
an outer surface of the continuously curved outer wall comprises a first
the outer face of the central protuberance comprises a second material,
the first material is selectable to at least partially define the first component of the total web tension, and
the second material is selectable to at least partially define the second component of the total web tension.

15. An end cap for a printing substrate roll configured to engage with a print roll retaining mechanism of a printer and to regulate a total web tension of a printing substrate as the printing substrate is fed from the printing substrate roll through the printer during a printing operation, the end cap having a generally cylindrical body comprising:
an attachment mechanism on a first side of the end cap configured to attach the end cap to the printing substrate roll;
a continuously curved outer wall in a second opposing side of the end cap, the continuously curved outer wall being longitudinally aligned with the generally cylindrical body, an outer surface of the continuously curved outer wall configured to contact a saddle of the print roll retaining mechanism, the continuously curved outer wall configured to define a first component of the total web tension;
a circular lateral wall encompassed by the continuously curved outer wall; and
a central protuberance that is concentric with the continuously curved outer wall, the central protuberance being longitudinally aligned with the generally cylindrical body, an outer face of the central protuberance being extended beyond an outer lip edge of the cylindrical outer wall, a base of the central protuberance being attached to a center of the circular lateral wall, the base being on an opposing end of the central protuberance relative to the outer face, the outer face of the central protuberance configured to contact a tensioning member of the print roll retaining mechanism, the central protuberance configured to define a second component of the total web tension.

16. The tensioning system of claim 14, wherein an outer surface of the circular lateral wall is disposed proximal to the first side of the end cap relative to the outer lip edge of the cylindrical outer wall, the circular lateral wall being a recess surface configured to receive an identification tag.

17. The end cap of claim 14, wherein a surface area of the continuously curved outer wall is selectable to define the first component of the total web tension, the surface area of the continuously curved outer having a direct relationship with the first component.

18. The end cap of claim 14, wherein a height and a width of the central protuberance are each selectable to define the second component of the total web tension, the each of the height and the width having a direct relationship with the second component.

19. The end cap of claim 14, wherein dimensions of the continuously curved outer wall and the central protuberance are independently selectable to cooperatively define the total web tension.

20. A tensioning system for regulating web tension of a printing substrate as the printing substrate is fed from a printing substrate roll through a printer during a printing operation, the tensioning system being at least one end cap and a print roll retaining mechanism, the at least one end cap configured to engage with the print roll retaining mechanism and having a generally cylindrical body, the at least one end cap comprising:
an attachment mechanism on a first side of the end cap configured to attach the at least one end cap to the printing substrate roll;
a continuously curved outer wall on a second opposing side of the at least one end cap, the continuously curved outer wall being longitudinally aligned with the generally cylindrical body, an outer surface of the continuously curved outer wall configured to contact a saddle of the print roll retaining mechanism, the continuously curved outer wall configured define a first component of the total web tension;
a circular lateral wall encompassed by the continuously curved outer wall, the circular lateral wall being inwardly disposed relative to an outer lip edge of the cylindrical outer wall, an outer surface of the circular lateral wall being a recess surface configured to receive an identification tag; and
a central protuberance that is concentric with the continuously curved outer wall, the central protuberance being longitudinally aligned with the generally cylindrical body, an outer face of the central protuberance being extended beyond the outer lip edge of the cylindrical outer wall, a base of the central protuberance being attached to a center of the circular lateral wall, the base being on an opposing end of the central protuberance relative to the outer face, the central protuberance configured to define a second component of the total web tension,
wherein dimensions of the continuously curved outer wall and the central protuberance are independently selectable to cooperatively define the total web tension.
